(19) United States
(12) Patent Application Publication
(10) Pub. No.: US 2004/0221156 A1
(43) Pub. Date: Nov. 4, 2004

(54) Module for secure transmission of data

(76) Inventors: Christophe Genevois, La Ciotat (FR); Jean-Luc Duahmel, Antibes (FR)

Correspondence Address: FINNEGAN, HENDERSON, FARABOW, GARRETT & DUNNER, LLP, 1300 I STREET, NW, WASHINGTON, DC, 20005, US

(21) Appl. No.: 10/415,141

(22) PCT Filed: Oct. 29, 2001
(86) PCT No.: PCT/EP01/12480

(30) Foreign Application Priority Data
Oct. 27, 2000 (DE) 100 53 390.6

(51) Int. Cl. H04L 9/00

(52) U.S. Cl. 713/154

(57) ABSTRACT

The invention relates to a module for secure transmission of data in a computer network. The module comprises a bidirectional interface to a computer connected to the network. the module being able to interchange packets, commands and messages with the computer via the interface. In addition, the module includes an interface to a smart card in which an identification is stored. Contained in the module is a filter logic circuit for filtering entitlement messages out of the packets received by the computer over the network and forwarded to the module via the bidirectional interface, a module control processor including a memory for computing at least one cryptographic key by means of the entitlement messages and by means of the identification stored in the smart card, and a decryption logic circuit which is able to separate the header from the content of the packets, to decrypt the content included in the packets of the cryptographic key computed by the processor and cooperating with a decryption method implemented in the hardware of the logic circuit, and to re-attach the header to the decrypted content of the packets, wherein the packets are subsequently routed back to the computer via the bidirectional interface.

### TECHNICAL FIELD

The invention relates to a module for secure transmission of data in a computer network in which data are transmitted in accordance with a network protocol, the data being arranged in packets consisting of a header and a content which may be encrypted.

### BACKGROUND

Secure transmission of data over computer networks is gaining increasing significance. Since the borderlines between the individual media end devices such as radio and television receivers and PCs are becoming increasingly blurred, it is especially for service providers of e.g. digital video broacasting (DVB) over the Internet that means for wide distribution of large volumes of data with access thereto permitted or denied are being sought for.

### SUMMARY OF INVENTION

An objective consistent with the invention is to provide a module for secure transmission of data in a computer network offering maximum security for a high data thruput whilst being simple to interface with existing computers. A module for secure transmission of data consistent with the invention comprises:

a bidirectional interface to a computer connected to the network, the module being able to interchange packets, commands and messages with the computer via the interface,

an interface to a smart card in which an identification is stored,

a filter logic circuit for filtering entitlement messages out of the packets received by the computer over the network and forwarded to the module via the bidirectional interface,

a module control processor including a memory for computing at least one cryptographic key by means of the entitlement messages and by means of the identification stored in the smart card,

a decryption logic circuit which is able to separate the header from the content of the packets, to decrypt the content included in the packets of the cryptographic key computed by the processor and cooperating with a decryption method implemented in the hardware of the logic circuit, and to re-attach the header to the decrypted content of the packets, wherein the packets are subsequently routed back to the computer via the bidirectional interface.

Such a module may have the advantages of, for one thing, very fast data decryption in a hardware logic circuit in thus enabling a large volume of data to be processed in a short time as is particularly significant for DVB. For another, the module may be substantially better safeguarded by its encrypted data and codes against unauthorized (hacker) access than a software decoder in an open unsecure environment as represented by a computer.

Also, consistent with the invention, a module for secure transmission of data may comprise:

a first interface to a computer network, the module being able to receive packets from the computer network via the interface,

a second interface to a computer, the module being able to send packets to the computer via the second interface,

an interface to a smart card in which an identification is stored,

a filter logic circuit for filtering entitlement messages out of the packets received from the network and forwarded to the module via the first interface,

a module control processor including a memory for computing at least one cryptographic key by means of the entitlement messages and by means of the identification stored in the smart card,

a decryption logic circuit which is able to separate the header from the content of the packets, to decrypt the content included in the packets of the cryptographic key computed by the processor and cooperating with a decryption method implemented in the hardware of the logic circuit, and to re-attach the header to the decrypted content of the packets, wherein the packets are subsequently forwarded to the computer via the second interface.

This configuration may make it possible to simply insert the module into the connection to the computer network, thus eliminating the need for an additional interface to the computer.

### BRIEF DESCRIPTION OF THE DRAWINGS

The invention will now be detailed by way of preferred embodiments with reference to the attached drawings in which:

FIG. 1 is a block circuit diagram of a first embodiment of a module in accordance with the invention;

FIG. 2 is a block circuit diagram illustrating one possible application of the module as shown in FIG. 1 in a network;

FIG. 3 is a block circuit diagram of a second embodiment of a module in accordance with the invention; and

FIG. 4 is a block circuit diagram illustrating one possible application of the module as shown in FIG. 3 in a network.

### DETAILED DESCRIPTION

The invention relates furthermore to a system for secure transmission of data between two computers which are connected to each other by a computer network.

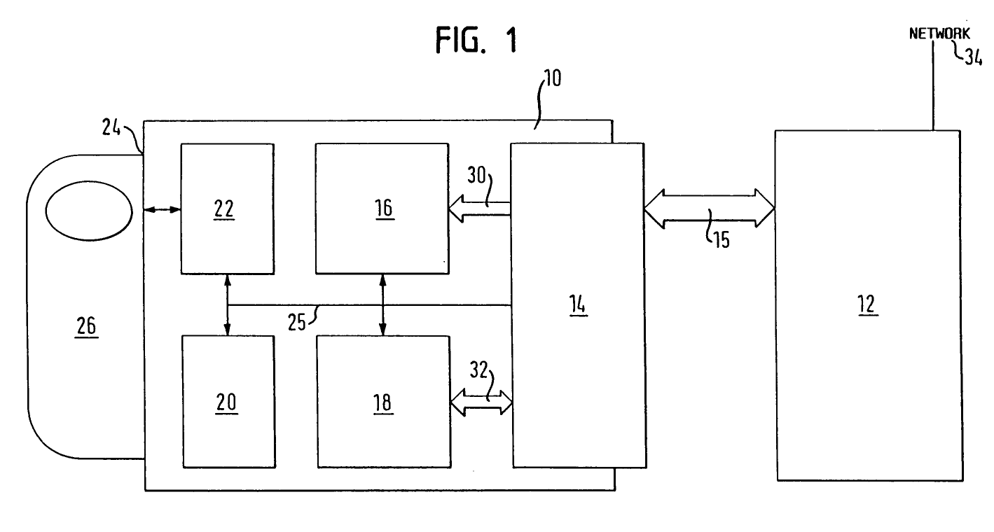

Referring now to FIG. 1 there is illustrated a module 10 in accordance with the invention which is provided for the conditional access (CA) to media content from a network, e.g. the Internet. In this network, packets are transported in accordance with a network protocol, e.g. the known Internet protocol, whereby the media content may be encrypted in the packets. In this embodiment the module 10 is configured as a PCMCIA card for a slot in a computer, preferably a laptop 12 connected to a computer network 34. The module 10 itself includes a bidirectional interface module 14, simply termed bidirectional interface 14 in the following, a processor 20 including a memory and an interface module 22 to a slot 24 (not shown) for a smart card 26, simply termed smart card interface in the following. The processor 20 connects via control lines 25 with all other assemblies of the module in controlling the functions of the module 10. The bidirectional interface 14 is connected via the bus 15 to an interface module (not shown) in the computer 12. Via the bus 15 the module is able to receive from the computer packets received over the network 34 for forwarding to the computer 12 after decryption. It is in addition conceivable for the module 10 to communicate via the bus 15 with the computer 12, making it possible to operate the module 10 from the computer 12. Via a connection 30 the bus 15 permits relaying data to a filter logic circuit 16 and via a second connection 32 the interchange of data with a decryption logic circuit 18.

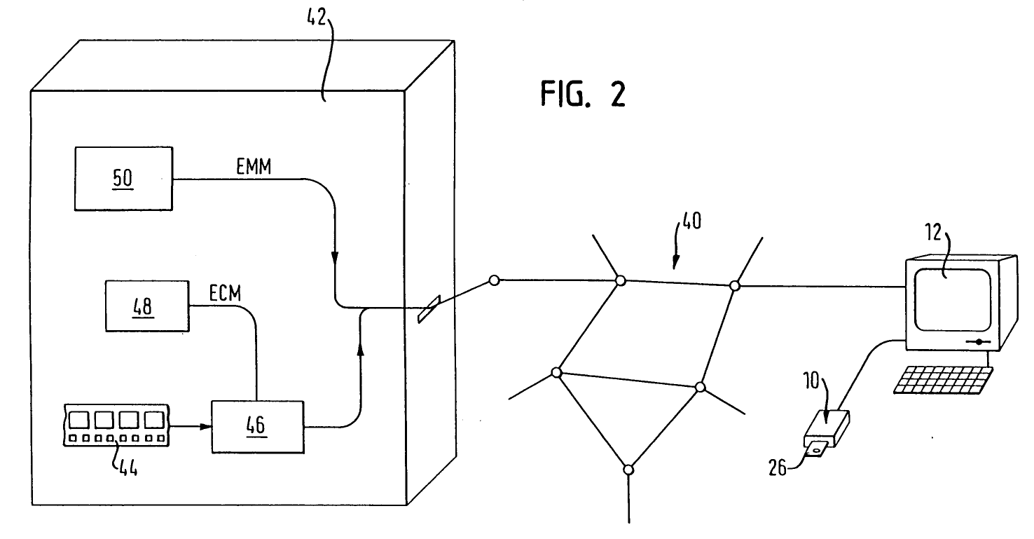

Referring now to FIG. 2 there is illustrated a detail of a network 40 to which the computer 12 is connected. Connected in this case to the network 40 is the computer of a service provider 42 which in this embodiment furnishes digital video broadcasting (DVB).

The function of the module 10 will now be described by way of example with DVB from service provider 42 to the computer 12 of the customer.

The service provider 42 furnishes a DVB signal 44 for dispatching over the network 40 in packets so that only entitled customers are able to receive and read this signal. For this purpose the signal is enveloped by known ways and means into packets and the content of the packets encrypted in an encoder 46 (also termed scrambler) into scrambled key words generated in a word generator 48. The information needed to decrypt the packets is dispatched as entitlement control messages (ECMs) and entitlement management messages (EMMs) together with the signal in the packets. In this arrangement the EMMs contain user-specific data entitling a customer or circle of customers to specific programs (Pay per Channel) or specific broadcasts (Pay per View). Assignment to a specific customer or specific circle of customers is produced by a unique ID as may be memorized in the smart card, for instance. This is why the service provider maintains in a data base 50 the corresponding customer data so that the EMMs can be dispatched automatically. By contrast, the ECMs contain data specific to the program, namely key words, by means of which the packets can be decrypted. To further hamper unauthorized access, the key words are frequently changed during transmission. The ECMs are sent much more frequently than the EMMs since the data specific to the user seldom changes as compared to the key words.

The packets are sent over the network 40 which may be, for example, the Internet, a private network or a corporate Intranet. In this arrangement they are previously provided with a header specific to the network protocol in each case and containing information specifically important for communication into the network. In the Internet protocol (IP) this may be, for example, information as to the version of the protocol, the header length, the nature of the service, the total length of the packet, the time to live of the packet. a checksum, the nature of the host transport protocol (e.g. TCP/UDP), the computer source address and computer destination address.

The computer 12 which may be connected e.g. via a modem 46, as shown, via a network card, or in some other way to the network, receives the packets and forwards them first, without being processed further, via the PCMCIA interface to the module 10. The packets can be forwarded to both the filter logic circuit 16 and to the decryption logic circuit 18. The filter logic circuit filters out any EMMs and ECMs contained in the data and forwards them to the processor 20 via the bus 25.

When the processor 20 receives an EMM destined for the customer as identified by the ID contained in the smart card 26, it loads the information contained therein into the memory where it is held until it can be overwritten by updated information from a new EMM. This information includes, for example, entitlement to a specific broadcast or program. When the processor 20 then receives ECMs relating to this specific broadcast or program it is then able to compute the cryptographic key for decrypting the content of the packet making up the broadcast with the aid of this information and the ID held in the smart card 26. The computed keys are forwarded by the processor 20 to the decryption logic circuit 18. The decryption logic circuit 18 comprises a hardware logic circuit (not shown in detail) which separates the header of the packets from the content and deposits the header via the bus 25 in the memory. In other embodiments of the invention the hardware logic circuit may also be a component of the interface module 14 so that also the data for the filter logic circuit 16 via the connection 30 consists solely of the content of the packets.

The decryption logic circuit 18 uses the computed keys to decrypt the content of the packets by means of an encryption technique achieved in its hardware and to return the decrypted content to the interface. The hardware logic circuit then fetches the stored header from the memory and adds it to the now decrypted content of the packet so that the packet is reinstated in forwarding it via the bus 15 to the computer 12 where further processing can be done by usual ways and means. The content of the packets to which the customer has no entitlement cannot be decrypted by the decryption logic circuit 18. These packets are forwarded from the interface either not at all or unencrypted to the computer 12 so that they cannot be processed by the computer 12.

In the opposite direction, the interface 14 is able to receive packets with unencrypted content from the computer 12 as produced therein via its interface module (not shown) and the bus 15, encrypt the contents and return them to the computer 12 via the interface 14 and bus 15, the computer thereby then sending the packets over the network.

As evident from the description, the invention offers the advantage of convenient application since the computer can now be entitled to the services of the service provider without having to open the computer or to alter its hardware in any other way. As compared to the pure software solution, the invention offers the advantage by hardware implementation of the encryption logic that the processor of the computer is not additionally involved in decryption or encryption. This also makes for a significant increase in speed which is particularly vital to a fluid display where large DBV data volumes are involved.

Apart from this, such a module is independent of the operating system of the computer since it works purely at the protocol level of the network, thus resulting in the module offering a much broader scope of application than for a purely software-based decryption system.

However, the main advantage as compared to software-based security systems (e.g. conditional access systems achieved in software) is that hackers can no longer gain access to the keys and ECMs, EMMs over the network.

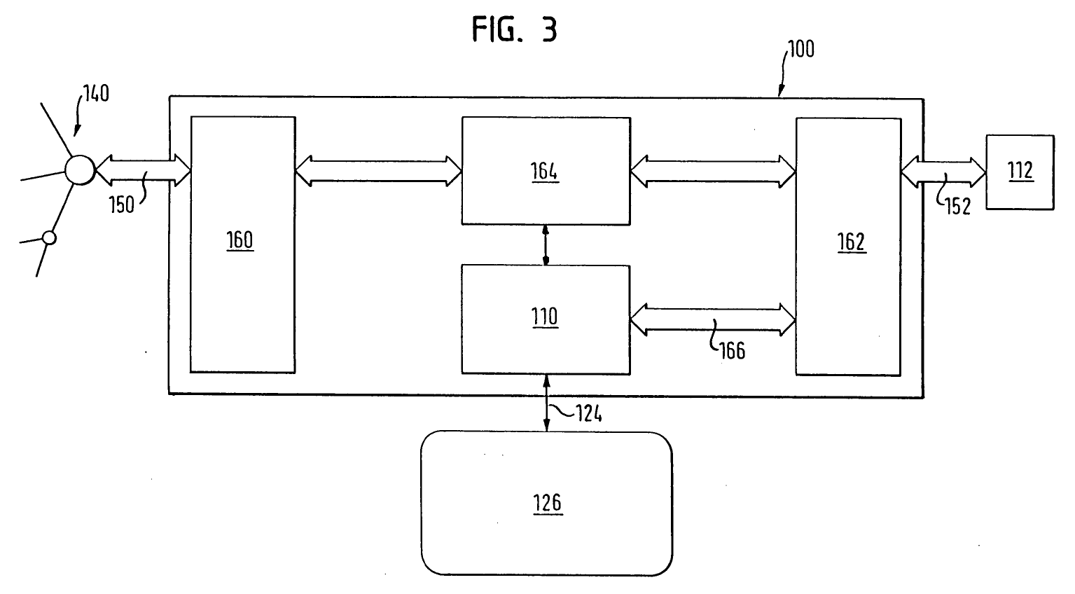

Referring now to FIG. 3 there is illustrated a second embodiment of the invention. The module 100 features a first interface 160 to a computer network 140 and a second interface 162 to a computer 112. Both interfaces work in accordance with the same protocol and at the same physical layer, for example Ethernet, so that the module 100 can be directly inserted into the network line 150 between the computer network 140 and computer 112. In the module 100 the interfaces 160, 162 merely handle the function of making the connection to the network, comparable to a network card in a computer. The interfaces 160 and 162 are connected to an IP switch 164 to which a conditional access (CA) unit 110 is coupled corresponding substantially to the module 10 as described in conjunction with the first embodiment.

The packets received from the network 140 are channeled through the IP switch 164 in which packets received via the first interface 160 destined by their IF address for the CA unit 110 are filtered out and supplied to the CA unit 110 which decrypts the data content of the packets as described above and returns the packets. The other packets, as well as the packets already decrypted by the CA unit 110, are directed by the IP switch 164 to the second interface 162 which sends the same via a network connecting line 152 to the computer 112. In addition, the CA unit 110 may include a connection 166 to the second interface 162, by means of which the module 100 can be controlled by the computer 112 via the network line 152.

The computer thus receives the packets dispatched encrypted by the service provider 42 already decrypted so that it is able to further handle them the same as the offers distributed in the network 140 without entitlement. For the remaining packets the module 100 may be additionally totally transparent, i.e. enabling the network link to continue undisturbed as if the module 100 were non-existent.

One special advantage afforded by this embodiment is the added simplicity in creating secure entitlement since no additional interface is needed at the computer 112 because the module 100 is looped into the network connection line 150 existing in any case. Apart from this, it is possible in this way to also provide entitlement to a partial network, i.e. a cluster of interconnected computers.

It will, of course, readily be appreciated that the application of the invention is not restricted to use with DVB. Since each module is able to decrypt the content of encrypted packets as well as to also encrypt unencrypted content, it is now possible instead with the aid of the module as described to securely communicate any content needing to be rendered secure, i.e. for example, e-mails sent in packets in accordance with a network protocol between two or more computers or between diverse partial network areas.

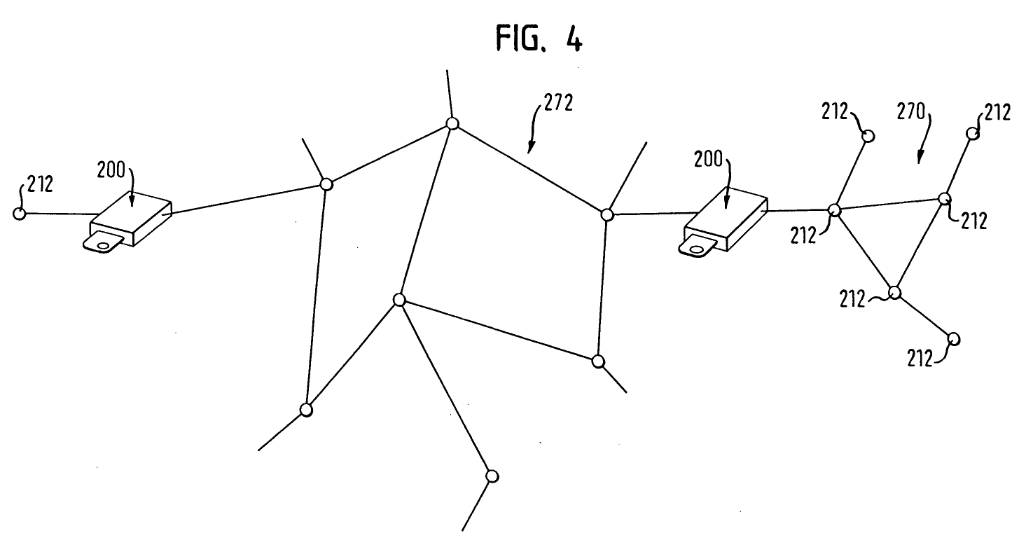

Referring now to FIG. 4 there is illustrated diagrammatically an example arrangement in which the modules 200 act as a kind of channeling device between a secure partial area 270, e.g. a corporate network, and an unsecure public area 272 of the network. In this case, each computer 212 or each partial area of the network 270 intended for access to the secure data is connected via a module in accordance with the invention to the public area of the network. Within the secure partial areas 270 the data requiring security are sent unencrypted, whilst outside, i.e. in the unsecure public area 272 of the network, the packets are transported exclusively with encrypted content. The module in accordance with the invention thus efficiently meets the function of a hardware firewall.

We claim:

1. A module for secure transmission of data in a computer network in which data are transmitted in accordance with a network protocol, said data being arranged in packets consisting of a header and a content which may be encrypted, comprising
a bidirectional interface to a computer connected to said network, said module being able to interchange packets, commands and messages with said computer via said interface,
an interface to a smart card in which an identification is stored,
a filter logic circuit for filtering entitlement messages out of said packets received by said computer via said network and forwarded to said module via said bidirectional interface,
a module control processor including a memory for computing at least one cryptographic key by means of said entitlement messages and by means of said identification stored in said smart card,
a decryption logic circuit which is able to separate said header from said content of said packets, to decrypt said content included in said packets by means of said cryptographic key computed by said processor and cooperating with a decryption method implemented in the hardware of said logic circuit, and to re-attach said header to said decrypted content of said packets, wherein said packets are subsequently routed back to said computer via said bidirectional interface.

2. The module according to claim 1, wherein said decryption logic circuit is arranged such that it is able to encrypt content of data packets which have been generated in said computer and have been received by said modul via said bidirectional interface by the aid of a cryptographic key computed by said processor by means of said identification stored in said smart card, said key cooperating with an encryption method implemented in the hardware of said logic circuit, wherein said packets are subsequently routed back to said computer via said bidirectional interface, said computer adding a header to said packets and forwarding said packets to said network.

3. A module for secure transmission of data in a computer network in which data are transmitted in accordance with a network protocol, said data being arranged in packets consisting of a header and a content which may be encrypted, comprising
a first interface to a computer network, said module being able to receive packets from said computer network via said interface,
a second interface to a computer, said module being able to send packets to said computer via said second interface,
an interface to a smart card in which an identification is stored,
a filter logic circuit filtering entitlement messages out of said packets received from said network and forwarded to said module via said first interface,
a module control processor including a memory for computing at least one cryptographic key by means of said entitlement messages and by means of said identification stored in said smart card,
a decryption logic circuit which is able to separate said header from said content of said packets, to decrypt said content included in said packets by means of said cryptographic key computed by said processor and cooperating with a decryption method implemented in the hardware of said logic circuit, and to re-attach said decrypted content of said packets to said header, wherein said packets are subsequently forwarded to said computer via said second interface.

4. The module according to claim 3, wherein said first and said second interfaces are each bidirectional and said decryption logic circuit is arranged such that it is able to separate said header from the content of said packets which have been generated in said computer and which have been received via said second interface, to encrypt said content included in said packets by the aid of a cryptographic key computed by said processor by means of said identification stored in said smart card, said key cooperating with an encryption method implemented in the hardware of said logic circuit, and to re-attach said header to the encrypted content of said packets, wherein said packets are subsequently forwarded to the network via said first interface.

5. The module according to claim 3 or 4, wherein a selecting device is provided between said module and both said interfaces, said device forwarding a packet from one of said interfaces to said module if it recognizes on the base of the information in said header that the packet is destined for decryption and encryption, respectively, in said module, and forwarding said package to said other interface if it recognizes on the base of the information in said header that said packet is not destined for decryption and encryption, respectively, in said module.

6. The module according to one of the preceding claims for receiving a digital television program (DVB) in which said entitlement messages filtered out from said packets by said filter logic circuit comprise, on the one hand, entitlement managing messages (EMM) including user-specific entitlement information and, on the other hand, entitlement control messages (ECM) including transmission-specific entitlement information, and wherein said processor stores said EMMs into said memory and computes said cryptographic key by means of said EMMs, said ECMs and said identification stored in said smart card.

7. The module according to one of the preceding claims which is provided with a memory for asynchronously arriving packets and comprises a clock generator by means of which it is able to synchronously forward said stored packets after said decryption of said encryption.

8. The module according to one of the preceding claims, characterized in that said packets include emails.

9. A system for secure transmission of data between computers which are connected with each other by a computer network in which data are transmitted in accordance with a network protocol, characterized in that at least two computers of said computer network are connected to a module according to one of the preceding claims.
